(19) United States
(12) Patent Application Publication
(10) Pub. No.: US 2008/0094406 A1
(43) Pub. Date: Apr. 24, 2008

(54) Stripe-Based Image Data Storage

(75) Inventors: Juergen Weese, Aachen (DE); Gundolf Kiefer, Aachen (DE); Marc Busch, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/573,369

(22) PCT Filed: Jul. 25, 2005
(86) PCT No.: PCT/IB05/52495

§ 371 Date: Feb. 7, 2007

(30) Foreign Application Priority Data
Aug. 11, 2004 (EP) 04300527.1

(51) Int. Cl. G06T 1/60

(52) U.S. Cl. 345/544

(57) ABSTRACT

The present invention relates to a way of storing 3D images. The 3D image is composed of a stack of two-dimensional video data subsets represented by arrays of pixel data. Each array of pixel data is partitioned into a plurality of overlapping and adjacent vertical stripes of pixel data having a width at most equal to a cacheline of the memory. The upper most left stripe is stored first and each stripe is stored after the left adjacent stripe. When storing each stripe having multiple rows of pixel data, the upper row is stored first and the first pixel data of each subsequent row of the stripe is stored in a memory location coming after a memory location where the last pixel data of the preceding row in the stripe is stored.

### FIELD OF THE INVENTION

The present invention relates to the storage of three-dimensional (3D) images and the optimization of memory bandwidth.

### BACKGROUND OF THE INVENTION

Video and display technologies are among new tools now available to doctors to assist them in making diagnosis. Due to the nature of medical images and the purposes that these images serve, work is needed to adapt current video techniques to the specific constraints of the medical field. Medical experts rank features that video techniques offer in a somewhat different order from what is common in other video applications such as video games or movie editing. And among all, the features that matter the most to medical teams are interactivity, accuracy, and consistency with the reality and the proportions. Video data thus needs be handled and conceptualized in a new manner.

Along with gaming, medical applications are certainly the two prominent areas where 3D images have been most successful. A main drawback with 3D images is however the size of the data sets that processors treat in short amount of times. Processing large 3D data sets can rapidly become an obstacle to proper data visualization and will often slow down processes to unacceptable levels unless solutions are found to optimize data access, data transfer and data processing. Current central processing units (CPUs) access data stored in the main memory via a cache hierarchy. Commonly, two cache levels are present and the first level cache is often much smaller than the second level cache. Data access is fast for the first level cache and relatively slow for the main memory. Data transfers are usually done via cachelines, which are the amount of data transferred at once between two memory entities or cache entities. Last generation processors have for example cachelines of up to 128 bytes and this number is still increasing. A memory organization based on caches may lead to severe drops in performance during runtime of algorithms that use only a few data of a cacheline, but touch a large number of cachelines. Running such type of algorithms requires excessive data transfers. While some algorithms are generally slow because of this architecture, the performance of other algorithms breaks down by a factor of up to 10 for distinct parameter ranges. There is thus great need to find solutions that reduce the amount of transferred data.

In digital image processing, a first solution was contemplated to optimize data transfers. Document U.S. Pat. No. 6,028,612, herein incorporated by reference, discloses a memory architecture that reduces memory bandwidth when retrieving an array portion of the picture from the memory. The memory is subdivided into a plurality of words for storing a picture having rows and columns. The picture is partitioned into two or more stripes each having a predetermined number of columns. The number of bytes in one row of one stripe is equal to the number of bytes in one word, for storing the data in one row of a stripe in one word. For the case of progressive video sequences or images the memory is organized in frame structure. For a frame picture to be stored in a frame organized memory or a field picture to be stored in a field-organized memory, the data in the first row of one of the stripes is stored in a first word. The data in each subsequent row of the stripe is stored in a word having a word address adjacent and subsequent to the word storing the data of the directly preceding row. The solution proposed in this document only partially solves the problem of an excessive number of transmitted cachelines while data processing. For example, processing of the stripes edge pixels still necessitates the retrieval of several distinct cachelines and thus unduly lengthens data transfers. In addition, because of structural considerations, the proposed implementation has the main drawback to limit the stripes width to a word length.

### SUMMARY OF THE INVENTION

There is thus a need in the industry to develop a solution that optimizes the storing of three-dimensional array of data that is ultimately processed and/or displayed.

To this end, a method is presented for storing in a memory a three dimensional array of information data samples respecting a three-dimensional object. In a first step, the array of information data samples is partitioned into a plurality of overlapping and adjacent vertical stripes. The stripes are stored one after the other in the memory starting with the upper left stripe: the upper left stripe is stored first and each subsequent stripe is stored after the stripe on its left is stored. Each individual stripe is composed of multiple rows of samples and is stored as follows: the upper row is stored first and the rows are stored one after the other from top to bottom. That is the first information data sample of each row of the stripe (omit the first row) is stored at a memory location coming after a memory location where the last information data sample of the preceding row was stored.

The invention proposes to partition the array of information data samples associated with a 3D object into stripes and store the stripes in a contiguous manner, one after the other, starting with the sample at the top left corner. A characteristic of the invention is that the stripes are overlapping. Such redundancy permits to reduce the number of data sets required during data call. In an embodiment where data is accessed in cachelines, the redundancy may reduce the overall number of transmitted cachelines. For instance, display algorithms often require samples in the surroundings of specific sample and the number of transmitted cachelines may increase tremendously if the surrounding samples can only be found in distinct cachelines. Repeating information about the surrounding samples of the processed sample in the manner proposed by the invention thus enables to gather the data required for processing in a reduced number of cachelines. An advantage of one or more embodiments of the invention is to reduce the memory bandwidth thereby speeding up the overall performance of algorithms. In the medical field, information data samples may be measurement or radiation values associated with voxels of the 3D object.

In one or more embodiments of the invention, the stripes have the same width, which may be a fraction of a cacheline associated with the memory. In an embodiment where the memory is coupled to a first cache, and possibly a second or third cache level, the width of the stripes is at maximum the least of the one or two cachelines. There is thus a great chance that information data samples associated with the voxels around the voxel being processed are within the same cacheline than the voxel that is processed. In the interpolation algorithm example mentioned above, computing the interpolated value for a given sample is often based on the information data sample associated with neighboring voxels. If the width of the stripes is smaller than the cacheline, there is a great chance that the sample associated with neighboring voxels will be present in the same cacheline.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 illustrates a conventional method for storing 3D images;

FIG. 2 and FIG. 3 illustrate a method of the invention;

FIG. 4 show pixels that belong to an overlap between adjacent stripes according to the invention;

FIG. 5 is a memory of the invention; and,

FIG. 6 is a picture of the invention.

Throughout the drawing, the same reference numeral refers to the same element, or an element that performs substantially the same function.

### DETAILED DESCRIPTION

The invention relates to a way of storing 3D images that optimizes visualization and processing. Although the invention is particularly advantageous in the medical domain, its features are generic enough so that it can be applied to any sort of video application. The invention is based on the concept that 3D images can be represented as a stack of 2D slices. Each 2D slice is treated as a conventional 2D image and is basically composed of an array of columns and rows of pixel data. Pixel data can be colour values, luminance or chrominance values, opacity or reflectivity values depending on the video application and the designer's choice. Each 2D image can be thus graphically represented by a two-dimensional array of points, each point representing a pixel.

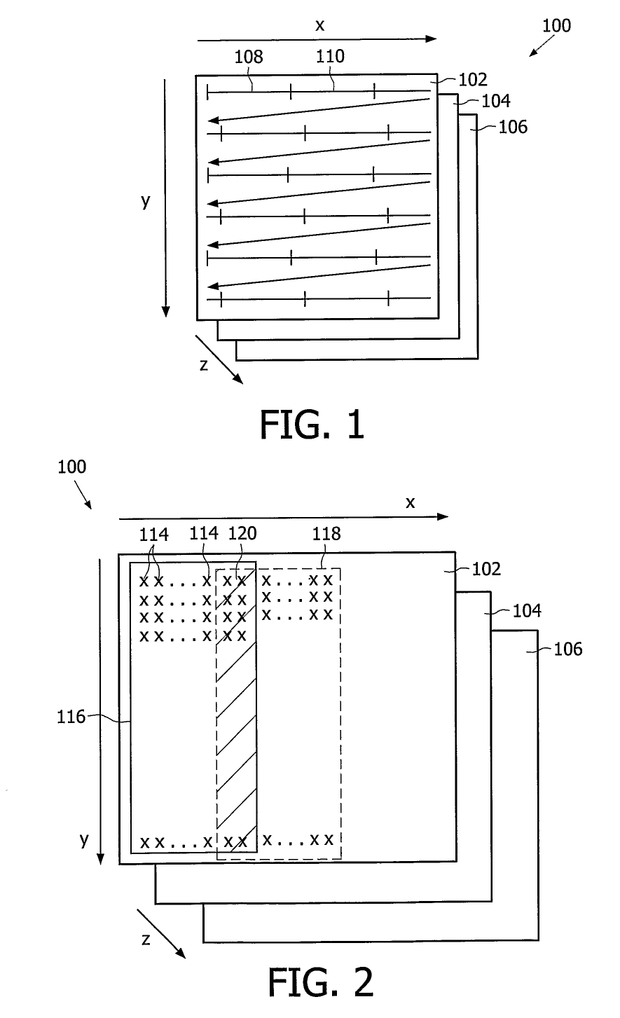

FIG. 1 shows 2D slices 102, 104 and 106 of a 3D image 100. 2D image 102 is represented in the drawing by a square array having six rows of pixel data. Conventionally, pixel data is stored in memory in series, row after row, starting with the pixel data in the upper left corner. For example, segment 108 of pixel data is stored in a first memory area, segment 110 is stored in an adjacent second memory area or in a next memory block, and so on until the last segment. A disadvantage of this embodiment is the discontinuities in the storage of a pixel and its upper and lower neighbours pixels. Indeed, adjacent pixels, especially in the vertical direction, will most certainly be stored in distinct and non-contiguous memory locations and different cachelines will be called upon when these pixels need to be retrieved.

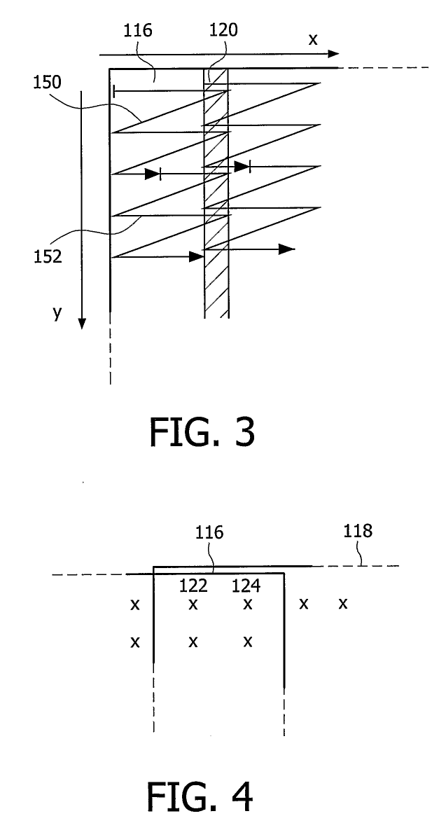

FIG. 2 and FIG. 3 illustrate some basic characteristics of the invention. Picture 102 is represented in the form of an array 114 of pixels positioned at regular intervals in the X and Y directions. In this exemplary embodiment, the array of pixels 114 is partitioned into a finite number of vertical overlapping stripes. Adjacent first and second stripes 116 and 118 are shown. Contrary to the embodiment shown in FIG. 1, pixels are stored in memory, stripe by stripe, which means that all pixels of a given stripe are stored together in a memory area. Stripe 116 may be stored first, starting with its pixel in the top left corner and adjacent stripe 118 is stored thereafter. The top left corner pixel of stripe 118 may be stored in a memory location adjacent to where the bottom right pixel of stripe 116 (pixel of stripe 116 stored last) was stored.

Stripe 116 is stored as follows. The pixel in the top left corner of stripe 116 is stored first and pixels are subsequently stored in series going right and down through stripe 116. Stripe 118 is stored in a similar fashion. In this embodiment, stripes 116 and 118 have the same width being a fraction of a cacheline of the memory. Segment 150 and 152 are cachelines stored in memory.

Additionally, as seen in FIG. 2, stripes 116 and 118 have an overlap 120 of two pixels, which means that pixel data in area 120 is redundant in memory. The choice of the number of overlapping pixels is arbitrary and may be selected to best fit implementation designs and memory load. Although it results in an overhead, data in overlap 120 is advantageously used for algorithms that require information on surrounding pixels. Indeed, the resulting data redundancy facilitates the performance of linear and cubic interpolations, for example, because information on the adjacent pixels is required to compute interpolation results. This is explained in more details with reference to FIG. 4.

FIG. 4 shows the last few pixels of the first row of stripe 116 and the first few pixels of the first row of stripe 118. As mentioned in a previous paragraph with respect to U.S. Pat. No. 6,028,612 if pixel data is stored in non-overlapping stripes, interpolation of the pixels at the edges requires access to the adjacent stripe, and thus access to different cachelines, memory areas or even different memory entities. Such implementation unduly restrains the process performance. In the invention where stripes overlap, an additional restriction may be put on the algorithm on which pixels in the overlap to process. In this embodiment, the interpolation algorithm will be restricted to process stripe pixels located within a portion of the overlap only and the algorithm will not process, and thus interpolate, pixels located outside the allowed overlap portion. For example, in reference to FIG. 4, when processing stripe 116, the interpolation algorithm is set up to only interpolate a pixel value for pixel 122 and the algorithm will not compute any interpolated value for pixel 124. Assuming that the interpolation algorithm only requires the pixel values of the closest pixels, the algorithm can easily compute a result for pixel 122 without requesting any additional cacheline. Similarly, when processing stripe 118, the interpolation algorithm is set up to compute an interpolation result for pixel 124 only. The edge pixels of each stripe 116 and 118 are ignored during processing of the stripe and since the information is redundant, the same edge pixels will be present in the adjacent stripe as non-edge pixels and thus still be processed in the end. This embodiment prevents unnecessary calls for cachelines that burden data links and consume bandwidth. The above is only given as an exemplary embodiment and any size of overlap may be chosen that satisfies the algorithm process. In a similar fashion, the width of the stripes 116 and 118 is selected to optimize the number of cacheline access during runtime. Stripes 116 and 118 may have different widths if needed.

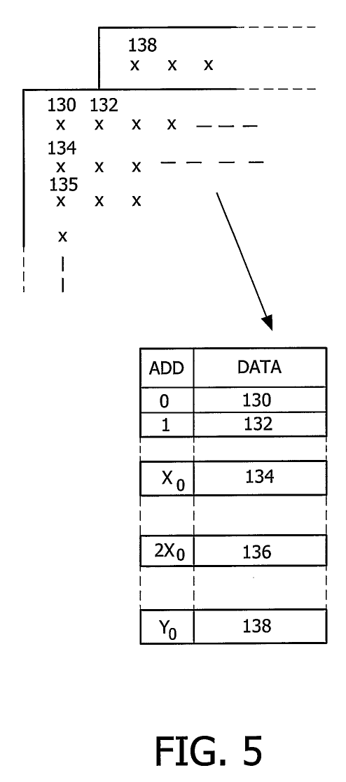

FIG. 5 illustrates an exemplary embodiment of the invention where memory addresses are assigned efficiently. FIG. 5 shows upper left corner pixel 130, and adjacent pixels 132-136 of 2D slice 102 and upper left corner pixel 138 of the next 2D slice 104 forming 3D image 100. FIG. 5 also includes a block unit representing internal organization of memory 140. Memory 140 is represented as a two-column table with memory addresses in the left column and data pixels in the right column. As shown, data associated with pixel 130 is stored at memory address 0, pixel 132 at address 1, pixel 134 at address X0, pixel 136 at address 2X0 and pixel 138 at address Y0. As explained above, pixels located in the same row are stored in series in memory 140 and first pixels of each row are stored in memory next to the last pixel of the preceding row. In this implementation, a constant address offset, namely X0, is introduced between a pixel and the pixel beneath it in the 2D slice. Pixels 130, 134 and 136 are therefore stored in memory 140 at addresses 0, X0 and 2X0, respectively. Pixel 142 located beneath pixel 132 is also stored in memory 140 at the address 1+X0. A similar address offset Y0 is introduced between pixels of slice 102 and pixels of slice 104. Indeed, pixel 130 and 138 are stored in memory 140 at respective addresses 0 and Y0. The introduced constant offsets allow a quick retrieval of pixel data related to neighboring pixels.

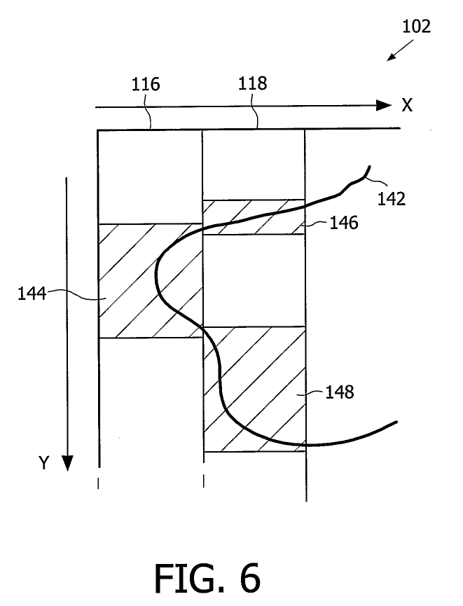

The proposed stripe-based storage method imposes a condition on the stripe width but leaves open the thickness and the height of the stripes. This freedom in the choice of the two remaining dimensions allows great flexibility during processing and virtual block building. In FIG. 6, image 102 includes contour 142 of a body organ. Contour 142 is the intersection with the plane of image 102 of the organ outer surface or shell. In order to process pixel data forming the contour 142, 2D virtual blocks, 114, 146 and 148 that include the whole contour 142 may be computed. The X dimension of virtual blocks 144, 146, 148 is the same as the width of the stripes 116, 188 and the Y dimension is left to the designer's choice. The Y dimensions of the blocks may be chosen to cover the stripe portion that includes the intersection of the contour and the stripe. Resulting virtual blocks 144-148 as seen in FIG. 6 are obtained.

It must be noted that 3D virtual blocks may also be built to cover the 3D shell of the body organ. To this end, a thickness in the Z direction is computed for blocks 144, 146 and 148. Compared with a traditional block-based storage implementation where fixed-size blocks are stored in memory, the invention permits greater flexibility and speeds up processes. Such implementation is particularly suited for medical applications where body surfaces or shells need be processed and visualized.

Moreover, although the disclosed storage architecture is based on cachelines, other storage arrangements are also well suited to the implement the invention. And other it may be more advantageous in view of the memory architecture to modify the width of the stripes which may be greater than a cacheline or other memory transfer entity.

Attention is also brought to the fact that the invention the slicing of the 3D array of pixels into 2D arrays is only given as an exemplary embodiment and the invention is first directed to 3D arrays of information data samples representative of physical data, radiation data, measurements results associated with voxels. Obviously, stripes may have a thickness of one or more information data samples.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method for storing in a memory a three dimensional array (100) of information data samples (114) respecting a three-dimensional object, characterized in that the method comprises:
partitioning the array of information data sample into a plurality of overlapping and adjacent vertical stripes (116, 118);
storing the upper most left stripe first and storing each stripe after the left adjacent stripe is stored; and,
when storing each stripe having multiple rows of information data samples, storing the upper row first and storing a first sample of each subsequent row in a memory location (0, X0, Y0) after a memory location where a sample of the preceding row is stored.

2. The method of claim 1, characterized in that the stripes have widths at most equal to a cacheline associated with the memory.

3. The method of claim 1, characterized in that all vertical stripes have the same width.

4. The method of claim 1, characterized in that the stripes have a same height than the array of information data.

5. The method of claim 1, characterized in that each sample and the sample beneath are stored in the memory with a constant address offset (X0, Y0).

6. The method of claim 1, characterized in that a thickness of the stripes is one information data sample and the juxtapositions of adjacent stripes form two-dimensional subsets (102, 104, 106) of the three-dimensional array.

7. The method of claim 6, characterized each first data sample in a first one of the two-dimensional subsets and each second data sample in a second one of the two-dimensional subsets with the same position in their respective subsets are stored in memory with a constant address offset.

8. The method of claim 1, characterized in that a thickness of the stripe is at least two information data samples.

9. The method of claim 1, characterized in that the information data sample is associated with a voxel of a three-dimensional picture.

10. A memory system comprising:
a memory arrangement comprising a main memory and a first level cache with a known cacheline; and,
a memory control unit for controlling a storing in the memory arrangement of a three-dimensional array of information data sample;
characterized in that the memory control unit partitions the array of information data samples into a plurality of overlapping and adjacent vertical stripes of samples having a width at least equal to the cacheline, and the memory control unit stores in the main memory the upper most left stripe first and stores each stripe after the left adjacent stripe; and, when storing each stripe having multiple rows of samples, the control unit stores the upper row first and stores a first sample of each subsequent row in a memory location coming after a memory location where a last sample of the preceding row is stored.

11. A record carrier containing computer executable instructions for storing in a memory a three dimensional array of information data samples respecting a three-dimensional object, characterized in that the storing comprises:
partitioning the array of information data into a plurality of overlapping and adjacent vertical stripes;
storing the upper most left stripe first and storing each stripe after the left adjacent stripe is stored; and,
when storing each stripe having multiple rows of information data samples, storing the upper row first and storing a first sample of each subsequent row in a memory location after a memory location where a sample of the preceding row is stored.
